(19) United States
(12) Patent Application Publication
(10) Pub. No.: US 2009/0253523 A1
(43) Pub. Date: Oct. 8, 2009

(54) INPUT SHAFT WITH INTERNAL DRY SPLINES AND SEALED PLUG AND METHOD OF MANUFACTURING A HYBRID POWERTRAIN UTILIZING THE SAME

(75) Inventors: Timothy J. Reinhart, Brownsburg, IN (US); Gregory W. Kempf, Avon, IN (US); Joel E. Mowatt, Zionsville, IN (US); Alan G. Holmes, Clarkston, MI (US); Grantland I. Kingman, Waterford, MI (US)

Correspondence Address: Quinn Law Group, PLLC, 39555 Orchard Hill Place, Suite 520, Novi, MI, 48375, US

(73) Assignees: GM GLOBAL TECHNOLOGY OPERATIONS, INC., Detroit, MI (US); GENERAL MOTORS CORPOATION, Detroit, MI (US)

(21) Appl. No.: 12/252,707

(22) Filed: Oct. 16, 2008

Related U.S. Application Data
(60) Provisional application No. 61/041,933, filed on Apr. 3, 2008.

(51) Int. Cl. F16C 3/00; B23P 19/02

(52) U.S. Cl. 464/182; 464/183; 29/525; 903/909

(57) ABSTRACT

An input shaft for a hybrid transmission includes a cylindrical hollow shaft portion having internal and external surfaces. The internal surface defines an internal cavity coaxial with the hollow shaft portion and has a splined portion configured to allow power to be transferred to the hollow shaft portion. The input shaft may further include a freeze plug press-fit in the internal cavity, configured to fluidly seal the inner cavity in embodiments with a cavity extending throughout the input shaft. The splined portion may be a broached spline. A method of manufacturing a hybrid powertrain includes forming a hollow transmission input shaft and press-fitting a plug into it, such that the shaft is internally fluid sealed. The shaft is mated to the transmission which may then be filled with fluid and tested for operability. The shaft may be dry-mated to an engine output member for common rotation therewith.

### CROSS-REFERENCE TO RELATED APPLICATIONS

This application claims the benefit of U.S. Provisional Application No. 61/041,933, filed Apr. 3, 2008, which is hereby incorporated by reference in its entirety.

### TECHNICAL FIELD

The present invention relates to vehicular drivetrains, and more particularly, to transmissions for hybrid and hybrid-type vehicles.

### BACKGROUND OF THE INVENTION

Internal combustion engines, particularly those of the reciprocating piston type, currently propel most vehicles. Such engines are relatively efficient, compact, lightweight, and inexpensive mechanisms by which to convert highly concentrated energy in the form of fuel into useful mechanical power.

Typically, a vehicle is propelled by such an engine, which is started from a cold state by a small electric motor and relatively small electric storage batteries, then quickly placed under the loads from propulsion and accessory equipment. Such an engine is also operated through a wide range of speeds and a wide range of loads and typically at an average of approximately a fifth of its maximum power output.

A vehicle transmission typically delivers mechanical power from an engine to the remainder of a drive system, such as fixed final drive gearing, axles and wheels. A typical mechanical transmission allows some freedom in engine operation, usually through alternate selection of five or six different drive ratios, a neutral selection that allows the engine to operate accessories with the vehicle stationary, and clutches or a torque converter for smooth transitions between driving ratios and to start the vehicle from rest with the engine turning. Transmission gear selection typically allows power from the engine to be delivered to the rest of the drive system with a ratio of torque multiplication and speed reduction, with a ratio of torque reduction and speed multiplication known as overdrive, or with a reverse ratio.

To operate properly, the transmission usually requires a supply of pressurized fluid, such as conventional transmission oil. The pressurized fluid may be used for such functions as cooling, lubrication, and, in some cases, operation of the torque transfer devices. The lubricating and cooling capabilities of transmission oil systems impact the reliability and durability of the transmission. Additionally, multi-speed transmissions require pressurized fluid for controlled engagement and disengagement of the torque transmitting mechanisms that operate to establish the speed ratios within the internal gear arrangement.

In hybrid vehicles, alternative power is available to propel the vehicle, minimizing reliance on the engine for power, thereby increasing fuel economy. Since hybrid vehicles can derive their power from sources other than the engine, engines in hybrid vehicles can be turned off while the vehicle is propelled by the alternative power source(s). For example, electrically variable transmissions alternatively rely on electric motors housed in the transmission to power the vehicle's driveline.

An electric generator can transform mechanical power from the engine into electrical power, and an electric motor can transform that electric power back into mechanical power at different torques and speeds for the remainder of the vehicle drive system. These functions may be combined into a single electric machine, a motor/generator. An electric storage battery used as a source of power for propulsion may also be used, allowing storage of electrical power created by the generator, which may then be directed to the electric motor for propulsion or used to power accessory equipment.

A series hybrid system allows the engine to operate with some independence from the torque, speed and power required to propel a vehicle, so the engine may be controlled for improved emissions and efficiency. Such a system may also allow the electric machine attached to the engine to act as a motor to start the engine. This system may also allow the electric machine attached to the remainder of the drive train to act as a generator, recovering energy from slowing the vehicle and storing it in the battery by regenerative braking.

An electrically variable transmission in a vehicle can simply transmit mechanical power from an engine input to a final drive output. To do so, the electric power produced by one motor/generator balances the electrical losses and the electric power consumed by the other motor/generator. By using the above-referenced electrical storage battery, the electric power generated by one motor/generator can be greater than or less than the electric power consumed by the other. Electric power from the battery can allow both motor/generators to act as motors. Both motors can sometimes act as generators to recharge the battery, especially in regenerative vehicle braking.

A power-split transmission can use what is commonly understood to be “differential gearing” to achieve a continuously variable torque and speed ratio between input and output. An electrically variable transmission can use differential gearing to send a fraction of its transmitted power through a pair of electric motor/generators. The remainder of its power flows through another, parallel, path that is mechanical.

One form of differential gearing, as is well known to those skilled in this art, may constitute a planetary gear set. However, it is possible to construct this invention without planetary gears, as by using bevel gears or other gears in an arrangement where the rotational speed of at least one element of a gear set is always a weighted average of speeds of two other elements.

A hybrid electric vehicle transmission system may include one or more electric energy storage devices. The typical device is a chemical electric storage battery, but capacitive or mechanical devices, such as an electrically driven flywheel, may also be included. Electric energy storage allows the mechanical output power from the transmission system to the vehicle to vary from the mechanical input power from the engine to the transmission system. The battery or other device also allows for engine starting with the transmission system and for regenerative vehicle braking.

### SUMMARY OF THE INVENTION

An input shaft for a hybrid transmission is provided. The input shaft includes a hollow shaft portion having an internal surface and an external journal surface. The internal surface defines an internal cavity coaxial with the hollow shaft portion. The internal surface has a splined portion configured to be dry-mated such that power may be transferred to the hollow shaft portion from an engine output member or test rig output member. The external journal surface is fluidly sealed by an input seal.

The input shaft may further include a freeze plug press-fit in the internal cavity, configured to fluidly seal the inner cavity in embodiments with a cavity extending throughout the input shaft. The splined portion may be a broached spline.

A method of manufacturing a hybrid powertrain is also provided. The method includes forming a hollow transmission input shaft and press-fitting a plug into the hollow transmission input shaft, such that the hollow transmission input shaft is internally fluid sealed. An input seal is installed in a transmission. The hollow transmission input shaft is then mated to the transmission, such that the input seal externally fluidly seals the hollow transmission input shaft, and the transmission is substantially complete.

The transmission may then be tested for operability by simulating engine output conditions and transmission operation conditions. The transmission or an assembled engine may then be transported to a common facility. The hollow transmission input shaft may be dry-mated to an engine output member, such that the hollow transmission input shaft and the engine output member are capable of common rotation.

The above features and advantages, and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic representation of a powertrain into which one embodiment of the present invention may be incorporated; and

FIG. 2 is a schematic cross section of the dry-mating interface between the engine output and transmission input shown schematically in FIG. 1.

### DESCRIPTION OF PREFERRED EMBODIMENTS

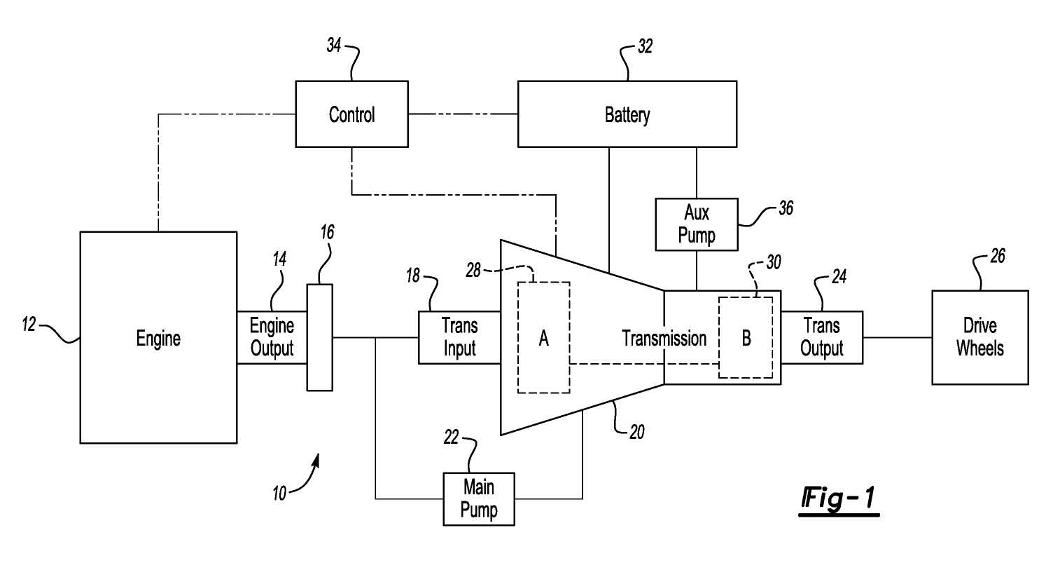

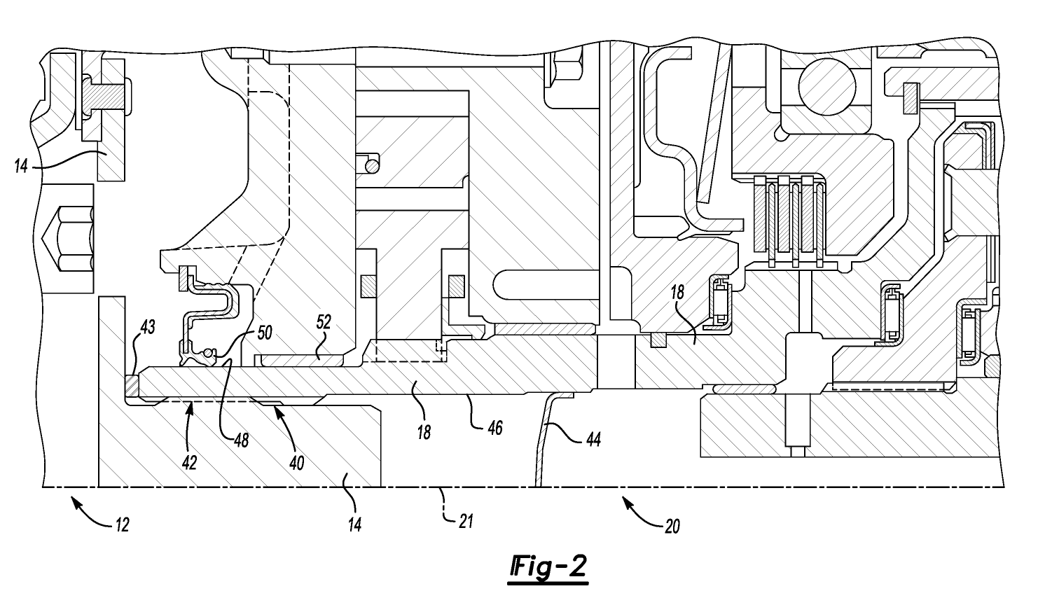

With reference to FIG. 1, there is shown a schematic diagram of a powertrain 10 into which the claimed invention may be incorporated. The powertrain 10 includes an engine 12, which may be any type of internal combustion engine known in the art, turning an engine output 14, which transmits the driving power produced by the engine 12. Driving power is then transferred through a transmission input shaft 18 into a transmission 20. In some embodiments, a damper 16 may be interposed between the engine output 14 and the transmission input shaft 18. Input shaft 18 is described in more detail below, with reference to FIG. 2.

Input shaft 18 may be operatively connectable to planetary gear members (not shown) or to torque transfer devices (not shown) within transmission 20. The transmission 20 may be an electrically variable transmission, a one- or two-mode input split transmission, a two-mode transmission with input-split and compound-split, or another hybrid transmission known to those having ordinary skill in the art.

Transmission 20 utilizes input shaft 18 to receive power from the vehicle engine 12 and a transmission output 24 to deliver power to drive the vehicle through one or more drive wheels 26. In the embodiment shown in FIG. 1, transmission 20 includes a first motor 28 and a second motor 30. Each of the motors 28 and 30 is a motor/generator capable of both converting electric power into mechanical power and converting mechanical power into electric power. The first motor 28 may also be referred to as motor A, and second motor 30 may be referred to as motor B.

The fluid in transmission 20 is pressurized by a main pump 22, which is directly or indirectly driven by rotation of the engine 12. The pressurized fluid may be used for such functions as cooling, lubrication, and, in some cases, operation of torque transfer devices.

The transmission 20 may utilize one or more planetary gear sets (not shown), and may utilize one or more clutches or other torque transfer devices (not shown) to provide input split, compound split, and fixed ratio modes of operation. The planetary gear sets may be simple or may be individually compounded.

The motors 28 and 30 are operatively connected to a battery 32, an energy storage device, such that the battery 32 can accept power from, and supply power to, the first and second motors 28 and 30. A control system 34 regulates power flow among the battery 32 and the motors 28 and 30 as well as between the motors 28 and 30.

As will be apparent to those having ordinary skill in the art, the control system 34 may further control the engine 12 and operation of the transmission 20 to select the output characteristics transferred to the drive wheels 26. Control system 34 may incorporate multiple control methods and devices.

As will further be recognized by those having ordinary skill in the art, battery 32 may be a single chemical battery or battery pack, multiple chemical batteries, or other energy storage device suitable for hybrid vehicles. Other electric power sources, such as fuel cells, that have the ability to provide, or store and dispense, electric power may be used in place of battery 32 without altering the concepts of the present invention.

In some modes of operation for the powertrain 10, the engine 12 may shut down or turn off completely. This may occur when the control system 34 determines that conditions are suitable for drive wheels 26 to be driven, if at all, solely by alternative power from one or both of motors 28 and 30, or during periods of regenerative braking. While the engine 12 is shut down, the main pump 22 is not being driven, and is therefore not providing pressurized fluid to transmission 20. Powertrain 10 may therefore include an auxiliary pump 36, which may be powered by the battery 32 to provide pressurized fluid to transmission 20 when additional pressure is required.

Referring now to FIG. 2, there is shown one possible embodiment of a portion of the powertrain 10 shown schematically in FIG. 1. More specifically, FIG. 2 shows a more detailed, cross-sectional view of the area transferring power from the engine 12 to the transmission 20. FIG. 2 shows only the upper half of transmission 20. Input shaft 18 is symmetrical about an axis 21, as are many of the other rotating members of transmission 20.

The engine 12 shown in FIG. 2 is transferring power through an engine output 14, which may be a crank shaft, a damper hub, or another shaft-type output capable of transferring power to the transmission 20. In this embodiment, power is transferred to the transmission 20 by a hollow, internally-splined input shaft 18. The input shaft 18 has internal dry splines 40 which may be mated to external dry splines 42 on the engine output 14. Splines 40 and 42 are maintained as dry splines by sealing them against pressurized transmission fluid contained in the transmission 20.

Dry splines, as opposed to wet splines, are not continuously in fluid communication with transmission fluid or engine oil. Dry splines may, however, have grease applied to one or both sets of splines 40 and 42 before installation. Such pre-installation grease assists in the dry-mating process and may provide any necessary lubrication for the life of the parts. Furthermore, an exterior seal 43 may be included to assist in retaining grease in the splined area for the life of the transmission 20. Exterior seal 43 may be located on the exterior surfaces between the input shaft 18 and engine output 14.

In the embodiment shown in FIG. 2, sealing against transmission fluid is accomplished with a freeze plug 44, which is an expandable plug, press-fit into an internal cavity 46 of the input shaft 18. However, as will be recognized by those having ordinary skill in the art, sealing could also be accomplished by an input shaft that is not completely hollow. Additionally, other seals could be used to plug the internal cavity 46 against transmission fluid, such as (without limitation) a seal which plugs the internal cavity 46 by threading into the walls of the internal cavity 46 or a seal configured to fit into a sealing groove (not shown) machined into the surface of the internal cavity 46.

Input shaft 18 is completely hollow, which allows the internal dry splines 40 to be manufactured as broached internal splines instead of shaped splines. As would be recognized by those having ordinary skill in the art, a broaching bar may be pulled through the internal cavity 46 to cut the internal dry splines 40. This broaching process may be via a keyway broach, multiple keyway broach, involute spline broach, a rotary broach, or any other suitable spline broaching tool known to those having ordinary skill in the art. Because the internal dry splines 40 are broached, there may be a significant cost improvement over having to shape the splines to manufacture the input shaft 18.

Opposite the internal cavity 46 of the input shaft 18 is an outer edge, the input shaft journal 48, which also must be sealed against pressurized transmission fluid in order to retain pressure within transmission 20. An input seal 50 and a bushing 52 ride against the input shaft journal 48—instead of riding against a damper or the engine output 14—and accomplish sealing of the input shaft journal 48. The input seal 50 and bushing 52 can therefore be installed along with the input shaft 18, which reduces the opportunity for cutting or damaging the seals and bushings during assembly of the transmission.

The input seal 50 and bushing 52 do not have to be in contact with the engine output 14 or test equipment used to test operability of the transmission 20 by simulating the engine output 14 and engine and transmission operating conditions. This allows testing during or after the manufacturing process of the transmission 20 and prior to final assembly of the drivetrain 10. Mating the engine output 14 to the input shaft 18 with dry splines allows a one-time, one-step engagement of the input shaft journal 48 to the input seal 50 and bushing 52—because mating of the engine 12 to the transmission 20 does not involve contact with the input seal 50 and bushing 52.

By using the input seal 50 and freeze plug 44 to seal the input shaft 18, and by using dry splines 40 and 42 to mate the input shaft 18 to the engine output 14, the engine 12 and transmission 20 are connected at a single, dry interface point (having only pre-installation grease). In the manufacturing process, this allows dry-mating the input shaft 18 to the engine output 14, which may reduce the difficulty, time, and cost of manufacturing the powertrain 10. Furthermore, the dry-mating process allows the transmission 20 to be filled with transmission fluid prior to mating the engine 12 and transmission 20, possibly even prior to shipping the transmission 20 to the final assembly point.

While the best modes for carrying out the claimed invention have been described in detail, those familiar with the art to which this invention relates will recognize various alternative designs and embodiments for practicing the invention within the scope of the appended claims.

1. An input shaft for a hybrid transmission receiving power from a driven member, comprising:
a cylindrical hollow shaft portion having an internal surface and an external journal surface, wherein said internal surface defines an internal cavity coaxial with said hollow shaft portion; and
a splined portion on said internal surface, such that power may be transferred from the driven member to said hollow shaft portion.

2. The input shaft of claim 1, wherein said splined portion is configured to be dry-mated to the driven member, such that said internal cavity is not in fluid communication with transmission fluid within the hybrid transmission.

3. The input shaft of claim 2, wherein said internal cavity is continuous throughout the input shaft, and further comprising a plug seal in said internal cavity, configured to fluidly seal said internal cavity.

4. The input shaft of claim 3, wherein said plug seal is a freeze plug press-fit into said internal cavity.

5. The input shaft of claim 4, wherein said splined portion is formed by broaching.

6. The input shaft of claim 5, wherein said splined portion is formed by multiple keyway broaching.

7. The input shaft of claim 5, further comprising an input seal configured to fluidly seal said external journal surface.

8. A method of manufacturing a hybrid powertrain, comprising:
forming a hollow transmission input shaft;
press-fitting a plug into said hollow transmission input shaft, such that said hollow transmission input shaft is internally fluidly sealed;
installing an input seal in a transmission;
mating said hollow transmission input shaft to said transmission, such that said input seal externally fluidly seals said hollow transmission input shaft; and
filling said transmission with transmission fluid.

9. The method of claim 8, further comprising:
attaching said transmission to a test rig by dry-mating said hollow transmission input shaft to a simulated engine output shaft; and
testing said transmission by simulating engine output conditions.

10. The method of claim 9, further comprising dry-mating said hollow transmission input shaft to an engine output member, such that said hollow transmission input shaft and said engine output member are capable of common rotation.

11. The method of claim 10, further comprising:
assembling an engine having said engine output member at a first facility;
transporting said assembled engine to a second facility; and
wherein said dry-mating said hollow transmission input shaft to said engine output member occurs at said second facility.

12. An input shaft for a hybrid transmission receiving power from a driven member, comprising:
a cylindrical hollow shaft portion having an internal surface and an external journal surface, wherein said internal surface defines an internal cavity coaxial with said hollow shaft portion, and continuous throughout the input shaft;
a freeze plug press-fit into said internal cavity and configured to fluidly seal said internal cavity; and
a splined portion on said internal surface, such that power may be transferred from the driven member to said hollow shaft portion.

13. The input shaft of claim 12, further comprising an input seal configured to fluidly seal said external journal surface.

14. The input shaft of claim 13, wherein said splined portion is formed by broaching.
